(19) United States
(12) Patent Application Publication
(10) Pub. No.: US 2026/0208747 A1
(43) Pub. Date: Jul. 23, 2026

(54) VEHICLE CONTROL WHILE PREDICTING THE FUTURE POSITION OF OTHER VEHICLES USING A COMBINATION OF A CONSTANT VELOCITY HEADING MODEL AND A LANE SNAPPING MODEL

(71) Applicant: Honda Motor Co., Ltd., Tokyo (JP)

(72) Inventors: David F. ISELE, Sunnyvale, CA (US); Piyush GUPTA, San Jose, CA (US); Sangjae BAE, San Jose, CA (US)

(21) Appl. No.: 19/034,209

(22) Filed: Jan. 22, 2025

(51) Int. Cl. B60W 50/00; B60W 40/04

(52) U.S. Cl. CPC B60W 50/0097; B60W 40/04; B60W 2050/0022; B60W 2552/10; B60W 2554/4026; B60W 2554/4029; B60W 2554/4041; B60W 2554/4042; B60W 2554/4045; B60W 2556/40

(57) ABSTRACT

A vehicle control system predicts future positions of a second vehicle using a sensor system, electronic control unit (ECU), and map database. The system identifies the second vehicle based on acquired sensor data and extracts relevant road information, including lane paths. The system estimates the second vehicle's state at a first time step, then predicts its future position at a second time step by assuming constant heading and velocity. The system generates two predictions: a constant velocity prediction and a lane-snapping prediction. It combines these to estimate a third future position and iteratively updates the second vehicle's state vector for subsequent prediction cycles using this estimate as the starting point.

### BACKGROUND

Modern vehicles operating in open environments, such as roadways, are increasingly equipped with advanced driver assistance systems (ADAS) and autonomous driving technologies. These systems aim to improve safety and enhance the driving experience by either supporting the driver or autonomously controlling the vehicle with little to no human intervention. A critical component of these technologies is the ability to accurately predict the behavior of other road users—such as vehicles and pedestrians—to navigate safely, avoid potential hazards, and ensure a comfortable ride. Predicting the future behavior of agents on the road presents challenges due to various factors, including the uncertainty of individual intentions, interactions between multiple agents, adherence to traffic rules, and dynamic environmental conditions.

To address these complexities, numerous neural network-based prediction models have been introduced, designed to capture the intricate dependencies and diverse scenarios that arise on the road. While these models may perform well on controlled datasets, they often struggle to adapt to real-world conditions that differ from their training data. This limitation raises concerns about their reliability and interpretability when applied to real-world autonomous driving. Moreover, the computational demands of these models—along with the need for extensive training and specialized input data—may create hurdles for practical deployment.

### BRIEF DESCRIPTION

According to one aspect, a vehicle control system is provided in a vehicle for predicting future positions of a second vehicle. The vehicle control system includes a vehicle sensor system and a vehicle electronic control unit (ECU). The vehicle sensor system is configured to acquire sensor data from a roadway environment surrounding the vehicle. The vehicle ECU is in communication with the vehicle sensor system, a vehicle actuator system of the vehicle, and a map database. The vehicle ECU is configured to: identify the second vehicle based on the sensor data acquired, extract, from the map database, road information for the roadway environment including information on a lane path for a lane in which the second vehicle is traveling; estimate a state vector of the second vehicle at a first time step based on the sensor data and the road information; generate a constant velocity prediction for the second vehicle at a second time step by assuming the second vehicle maintains a heading which remains constant and a velocity which remains constant, and estimate a first future position of the second vehicle based on the heading and the velocity; generate a lane snapping constant velocity prediction for the second vehicle at the second time step, and estimate a second future position of the second vehicle; estimate a third future position at the second time step by combining the first future position and the second future position; and iteratively update the state vector for a subsequent prediction cycle using the third future position as a starting point.

According to another aspect, a method for controlling a vehicle includes using a vehicle electronic control unit (ECU) to: identify a second vehicle, using sensor data acquired by a vehicle sensor system of the vehicle; extract, from a map database, road information including information on a lane path for a lane in which the second vehicle is traveling; estimate a state vector of the second vehicle at a first time step based on the sensor data and the road information; generate a constant velocity prediction for the second vehicle at a second time step by assuming the second vehicle maintains a heading which remains constant and a velocity which remains constant, and estimate a first future position of the second vehicle based on the heading and the velocity; generate a lane snapping constant velocity prediction for the second vehicle at the second time step, and estimate a second future position of the second vehicle; estimate a third future position at the second time step by combining the first future position and the second future position; and iteratively update the state vector for a subsequent prediction cycle using the third future position as a starting point.

According to another aspect, a vehicle includes a vehicle sensor system, a vehicle actuator system, and a vehicle electronic control unit (ECU) in communication with the vehicle sensor system, the vehicle actuator system, and a map database. The ECU is programmed to: identify a second vehicle different than the vehicle, using sensor data acquired by the vehicle sensor system of the vehicle; extract, from the map database, road information including information on a lane path for a lane in which the second vehicle is traveling; estimate a state vector of the second vehicle at a first time step based on the sensor data and the road information; generate a constant velocity prediction for the second vehicle at a second time step by assuming the second vehicle maintains a heading which remains constant and a velocity which remains constant, and estimate a first future position of the second vehicle based on the heading and the velocity; generate a lane snapping constant velocity prediction for the second vehicle at the second time step, and estimate a second future position of the second vehicle; estimate a third future position at the second time step by combining the first future position and the second future position; and iteratively update the state vector for a subsequent prediction cycle using the third future position as a starting point.

### BRIEF DESCRIPTION OF THE DRAWINGS

FIG. 1 is a schematic illustration of a vehicle including a vehicle control system, a vehicle sensor system, and a vehicle actuator system.

FIG. 2 is a block schematic illustrating exemplary components of the vehicle control system, the vehicle sensor system, and the vehicle actuator system.

FIG. 3 is an exemplary roadway illustrating information stored in a map database.

FIG. 4 is a block schematic illustrating exemplary components of the electronic control unit (ECU).

FIG. 5 is a schematic illustration of a vehicle traveling along a road, showing the velocity and heading of the vehicle.

FIG. 6 is a flow chart illustrating a method for controlling a vehicle.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted or organized with other components or organized into different architectures.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory,” as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive,” as used herein, may be a magnetic disk drive, a solid state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus,” as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database,” as used herein, may refer to a table, a set of tables, and a set of data stores (e.g., disks, drives, etc.) and/or methods for accessing and/or manipulating those data stores.

An “operable connection,” or a connection by which entities are “operably connected”, is one in which signals, physical communications, and/or logical communications may be sent and/or received. An operable connection may include a wireless interface, a physical interface, a data interface, and/or an electrical interface.

A “computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “vehicle,” as used herein, refers to any moving vehicle that is capable of carrying one or more human occupants, or cargo, and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system,” as used herein, may be any automatic or manual systems that may be used to enhance the vehicle, and/or driving. Exemplary vehicle systems include an advanced driver assistance system, an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pre-tensioning system, a monitoring system, a passenger detection system, a vehicle suspension system, a vehicle seat configuration system, a vehicle cabin lighting system, an audio system, a sensory system, among others.

The aspects discussed herein may be described and implemented in the context of non-transitory computer-readable storage medium storing computer-executable instructions. Non-transitory computer-readable storage media include computer storage media and communication media. For example, flash memory drives, digital versatile discs (DVDs), compact discs (CDs), floppy disks, and tape cassettes. Non-transitory computer-readable storage media may include volatile and non-volatile, removable and non-removable media implemented in any method or technology for storage of information such as computer readable instructions, data structures, modules, or other data.

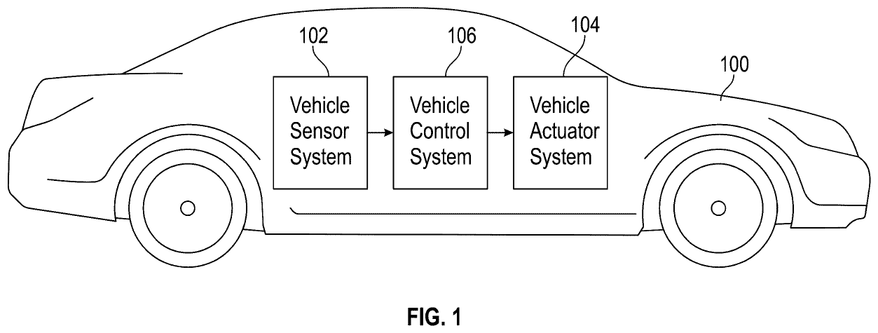

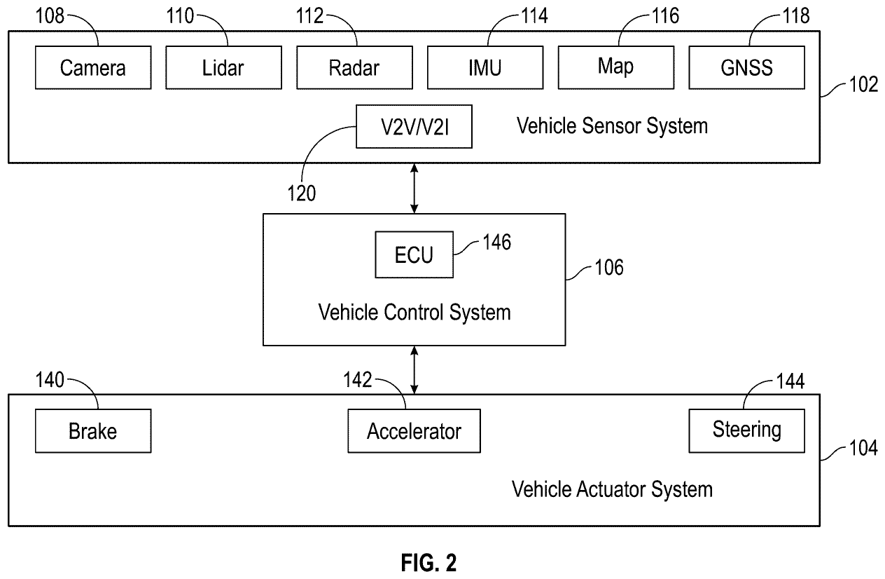

Referring to FIGS. 1 and 2 of the present application, a vehicle 100 is shown to include a vehicle sensor system 102, a vehicle actuator system 104, and a vehicle control system 106. The vehicle control system 106 has an operable connection that facilitates computer communication to and with the vehicle sensor system 102 and the vehicle actuator system 104. The vehicle control system 106 controls the vehicle sensor system 102 to retrieve environmental information (e.g., information related to an environment surrounding the vehicle, including other vehicles surrounding the vehicle), and receives the environmental information as input data from the vehicle sensor system 102. The vehicle control system 106 also receives operation information related to operating parameters of the vehicle 100 from the vehicle actuator system 104, and may operate to control the vehicle actuator system 104 autonomously, without relying on user input, or based on detected user inputs (e.g., via a steering wheel, accelerator, clutch and gear shift, etc.)

As described in further detail below, the vehicle control system 106 performs processing on the environmental information received from the vehicle sensor system 102 and the operating parameters of the vehicle 100 received from the vehicle actuator system 104, as well as preset and/or user inputs, to determine control of the vehicle 100 and to control the vehicle actuator system 104 to perform the determined control of the vehicle 100. The vehicle 100 as described herein may be an autonomous vehicle in which the vehicle control system 106 controls the vehicle actuator system 104 to drive the vehicle 100 with no or minimal user input, or a vehicle that employs an advanced driver assistance system which operates based on at least some user inputs via the vehicle actuator system 104.

The vehicle sensor system 102 may include any one or more sensors provided on or off the vehicle 100, which may be used to collect environmental information related to the environment in which the vehicle 100 is operating. For example, the vehicle sensor system 102 may include camera 108, a Lidar (Light Detection and Ranging) Device 110, a radar device 112, an inertial measurement unit (IMU) 114, a map database 116, a global navigation satellite system 118 (GNSS), and a vehicle-to-vehicle (V2V)/vehicle-to-infrastructure (V2I) system 120 that allows for communication with other vehicles and infrastructure support components.

The present application envisions that any and all of the components listed above as exemplary parts of the vehicle sensor system 102 may be included or omitted, in any combination. When included, the above components may be provided as a singular component or as a plurality of like components (e.g., the camera 108 may be provided as a plurality of cameras, the IMU 114 may be provided as a plurality of IMUs, etc.), situated and placed on any parts of the vehicle to facilitate the retrieval of the environmental information.

Additionally, the components of the vehicle sensor system 102 may be provided from known components configured to perform the functions known to be performed by the components. The components may be wholly embodied by devices which communicate with the vehicle control system 106, may be embodied by a device which requires processing either performed internally or by the vehicle control system 106, or may be entirely embodied by processing performed by the vehicle control system 106, e.g., based on information received by a vehicle receiver or transceiver (not shown) in communication with the vehicle control system 106. For example: the map database 116 may be stored in a memory in the vehicle control system 106, or may be stored externally from the vehicle 100 and remotely communicated to the vehicle 100; and the processing associated with the GNSS 118 and the V2V/V2I 120 may be performed by the vehicle control system 106 based on information received by the receiver or transceiver. Additionally, as will be clear with reference to the below discussion, the vehicle control system 106 may perform processing on the environmental information data input from the vehicle sensor system 102 and uses the processed environmental information data to determine how to control the vehicle 100 via the vehicle actuator system 104.

With particular reference to the map database 116, it is noted that the map database 116 stores map information, which may include, e.g., information on roads, streets, and highways, including the lanes thereof, train rails, bicycle pathways and lanes, and pedestrian walkways. Among other information related to the aforementioned, the map database 116 stores lane path information, which identifies a path a lane follows, for each. In this regard, the lane path information may be of lanes on a roadway or, e.g., for pedestrians, a path of a sidewalk or crosswalk along or through a roadway.

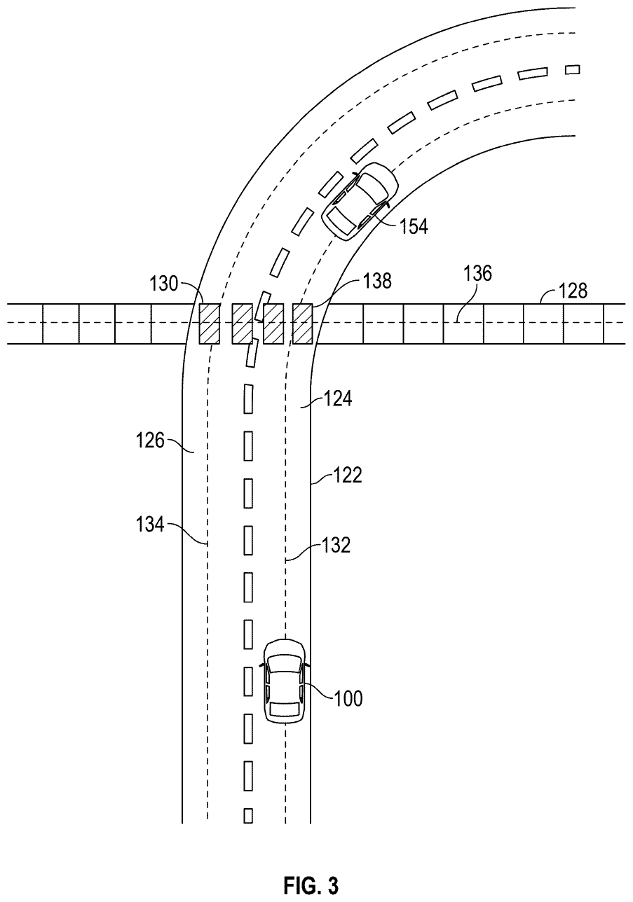

FIG. 3 depicts exemplary information stored in the map database 116. As shown, the map database 116 stores information on a road 122, which in one example may be divided into two lanes 124, 126, a pedestrian walkway 128 along the road 122, and a crosswalk 130 which cross the road 122. Also depicted in FIG. 3 is the lane path information stored for each of the two lanes 124, 126, the pedestrian walkway 128, and the crosswalk 130. Specifically, the first lane 124 may have a first lane path 132, the second lane 26 may have a second lane path 134, the pedestrian walkway 128 may have a third lane path 136, and the crosswalk may have a fourth lane path 138. Each lane path, as shown, may follow a direction of travel a vehicle or pedestrian or cyclist would be likely to follow (the first lane 124, the second lane 126, the pedestrian walkway 128, and the crosswalk 130), where a central traveling position may be assumed in the width direction of the lane path. It is to be appreciated that the depiction of FIG. 3 is only exemplary, and that all other types of roadways may be included in the map database 116 with lane path information. It is also noted that the road information may include, where applicable, lane path information for more than one lane, as in FIG. 3. All of the information shown in FIG. 3 except the vehicle 100 and the second vehicle 154 may constitute road information stored in the map database 116.

The vehicle actuator system 104 may include a brake 140, an accelerator 142, and a steering 144. The brake 140 is used to stop the vehicle 100, for example by halting rotation of wheels of the vehicle 100. The accelerator 142 is used to make the vehicle 100 drive (accelerate or maintain constant velocity), for example, by causing drive wheel(s) of the vehicle 100 to rotate. The steering 144 is used to direct a trajectory or heading of the vehicle 100, for example by turning wheels of the vehicle 100. To support autonomous driving, the brake 140, the accelerator 142, and the steering 144 may be entirely controlled by the vehicle control system 106 to cause the vehicle to drive, stop, and turn. To support driving of the vehicle 100 with an advanced driver assistance system, the brake 140, the accelerator 142, and the steering 144 may be controlled by the vehicle control system 106 to cause the vehicle to drive, stop, and turn based, in some part, on inputs by the driver of the vehicle 100, for example, via accelerator and brake pedals and a steering wheel (not shown), or like devices. The brake 140, the accelerator 142, and the steering 144, as well as their driver input devices, are all known components of a vehicle and may be provided in any manner or configuration.

The vehicle control system 106 includes an electronic control unit (ECU) 146. The ECU 146 may be a vehicle ECU that controls and monitors any and all vehicle functions. The ECU 146 may be configured by one or more processors, together with a memory on which a control program is stored, so that the ECU 146 functions as described herein when the processor(s) execute(s) the control program. The ECU 146 may be part of the central vehicle ECU or may be provided separately from the vehicle ECU via one or more processors or computers, with all or some of the functions being performed in the vehicle 100 or remote from the vehicle 100 with communication with the vehicle 100. Within the context of the instant application, the ECU 146 is configured to receive inputs from the vehicle sensor system 102 and the vehicle actuator system 104, and to control the vehicle actuator system 104 based on processing those inputs. It is again reiterated that the map database 116 may be provided as part of the vehicle sensor system 102, i.e., stored on a memory provided therewith, may be stored on a memory internal to the ECU 146, may be stored on a memory external to the ECU 146 but otherwise in the vehicle 100, or may be stored on a remote memory and communicated via a computer communication or other protocol to the ECU 146.

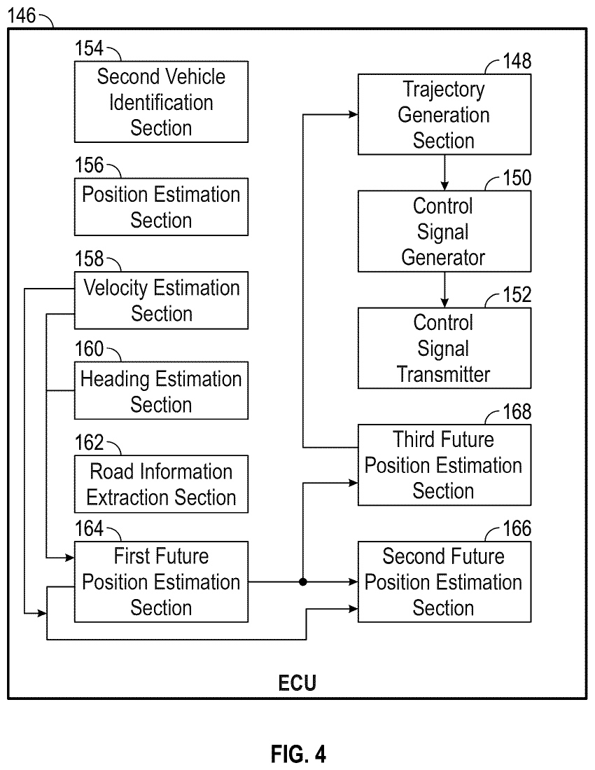

Among other aspects, and with reference to FIGS. 1-4, the ECU 146 is programmed or otherwise configured to include a trajectory generation section 148, a control signal generator 150, and a control signal transmitter 152. Briefly, the trajectory generation section 148 is configured to generate a trajectory of the vehicle 100 including reference waypoints using any known motion planning methods or systems. The trajectory generated by the trajectory generation section 148 is sent to the control signal generator 150, which generates control signals to be sent to the vehicle actuator system 104 for controlling the vehicle actuator system 104 to autonomously drive the vehicle 100 or to drive/control the vehicle in accordance with the advanced driver assistance system, to follow the trajectory generated by the trajectory generation section 148. The control signal transmitter 152 transmits the control signals generated by the control signal generator 150 to the vehicle actuator system 104.

In generating the trajectory, the trajectory generation section 150 may consider many inputs, including, e.g., environmental information related to the environment surrounding the vehicle 100, based on inputs from the vehicle sensor system 102, and user inputs, either directly to vehicle control devices or by inputting a desired destination (particularly for autonomous driving applications).

In FIG. 3, other vehicles in the roadway are depicted as an exemplary second vehicle 154 traveling in the first lane 124 generally along the first lane path 132. It is to be appreciated that the second vehicle 154, while only shown as one vehicle, may actually be a plurality of the second vehicles 154 and the processing described herein will be similarly applied to each of the plurality of the second vehicles 154. Additionally, while the second vehicle 154 is depicted as an automobile and labeled with the term “vehicle,” it may be a pedestrian, a bicycle, a train, or any other traffic participant.

Information related to the second vehicle 154 may be captured by the vehicle sensor system 102 (e.g., via the camera 108, the Lidar 110, the radar 112, or the V2V/V2I 120) and communicated to the ECU 146 for processing. For example, in processing information related to the second vehicle 154, the ECU 146 may include a second vehicle identification section 154, a position estimation section 156, a velocity estimation section 158, a heading estimation section 160, a road information extraction section 162, a first future position estimation section 164, a second future position estimation section 166, and a third future position estimation section 168. As will be described in detail below, the ECU 146 uses these listed elements/sections to determine both current information related to a state of the second vehicle 154, as well as to predict a future state or behavior of the second vehicle 154. It should be appreciated that while the various sections and elements of the ECU 146 are described, these sections and elements may be combined or further separated via the software and/or hardware architecture of the ECU 146.

As the vehicle 100 travels on the road 122, the vehicle sensor system 102 employs, among its other components, the camera 108, the Lidar 110, the radar 112, or the V2V/V2I 120 to detect the environment surrounding the vehicle 100. The inputs from the camera 108, the Lidar 110, the radar 112, or the V2V/V2I 120 may be processed by the ECU 146 at the second vehicle identification section 154 and the position estimation section 156 to identify the presence and estimate the position of the second vehicle 154. As exemplarily depicted in FIG. 3, the second vehicle 154 is in the same first lane 124 as the vehicle 100, generally traveling along the same first lane path 132 as the vehicle 100, and its presence is identified, and its position is estimated as such. The processing by which the second vehicle 154 is identified and its position estimated may be by any known processing for achieving such ends. It is reiterated that if there are a plurality of the second vehicle 154 in the environment (e.g., in the first lane 124, the second lane 126, the pedestrian walkway 128, or the crosswalk 130), each would be identified, and their position would be estimated (and the remaining processing described below would be performed for each).

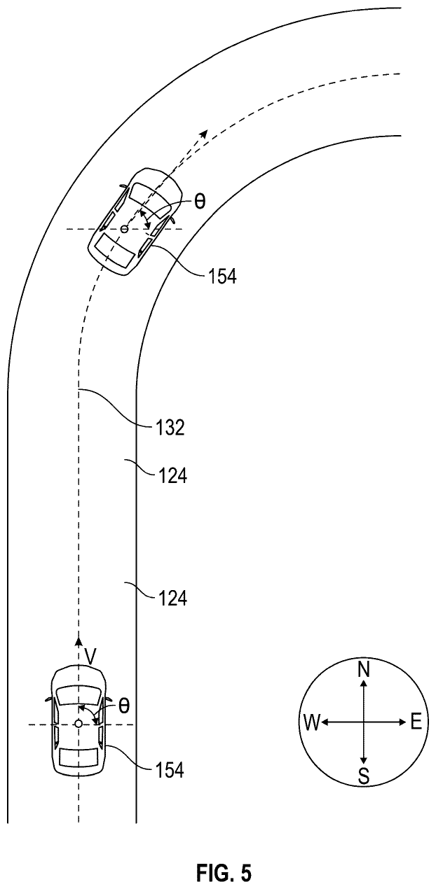

By taking a time series of position estimations of the second vehicle 154 by the position estimation section 156, the velocity estimation section 158, and the heading estimation section 160, the ECU 146 may estimate a velocity v of the second vehicle 154 and a heading θ of the second vehicle 154. The velocity v as used herein primarily refers to a speed of travel, with the heading θ referring to a direction of travel. The heading θ may, e.g., be defined with reference to any predefined axis. In FIG. 5, which depicts the second vehicle 154 traveling along the first lane 124, shows the heading θ as being defined relative to the axis that runs East-West, so a heading of true North would yield a 90° heading.

The aforementioned processing by the ECU 146 relates to an observed state of the second vehicle 154. However, improvements in the control of autonomous vehicles and/or vehicles that employ advanced driver assistance systems have been realized by employing predictive processing that predicts future behavior and/or position other vehicles on the roadway, e.g., of the second vehicle 154 on the road 122. It will be appreciated that the second vehicle 154 could, at any moment, engage in many types of rational or irrational, expected or unexpected behaviors. For example, the second vehicle 154 may suddenly turn, swerve, or apply a strong brake bringing the second vehicle 154 to a stop or near stop, and may do so either as a rationale behavior (e.g., an obstacle such as a pedestrian suddenly entered the road 122) or as an irrational behavior (e.g., the driver has a medical emergency, commits an error when driving, etc.)

Predictive models have been proposed which attempt to capture all of the possible actions and behaviors the second vehicle 154 may take on the road 122. For example, multi-modal and interactive prediction models utilizing deep learning to handle the complex interdependencies have been proposed. While these models often perform well on fixed datasets, these models may have limitations when working with real world systems. Additionally, these models may significantly add to the computational load of the ECU 146, for example, while requiring significant training of the models.

The vehicle 100, the vehicle control system 102, and method 600 for controlling the vehicle 100 of the instant application address the drawbacks of the proposed predictive models by performing predictive processing while assuming the second vehicle 154 will travel at a constant velocity v and at a constant heading θ (i.e., a constant velocity heading), while modifying these assumptions to apply a lane snapping model in which the second vehicle 154 is assumed to follow the lane path of the lane in which it is traveling.

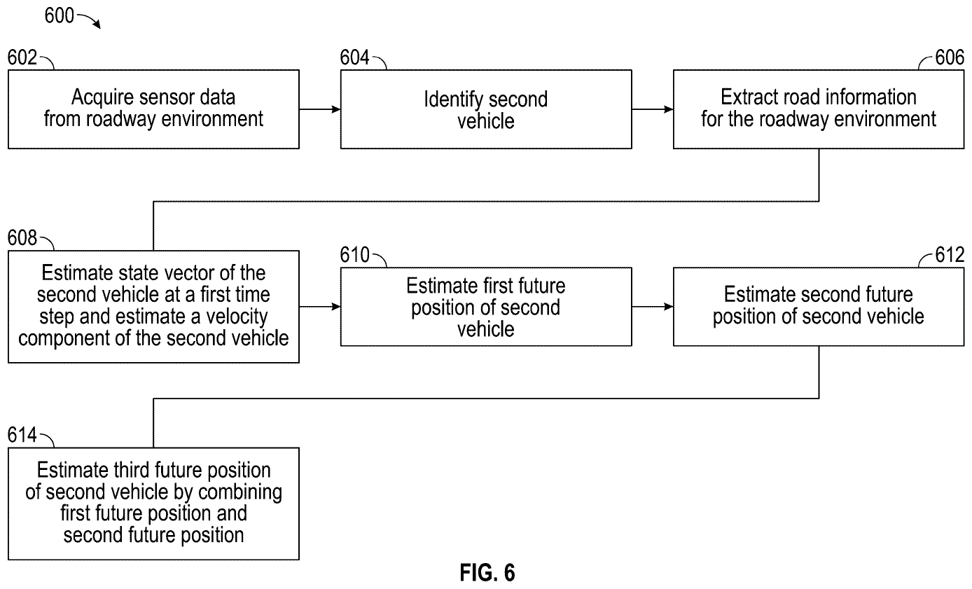

To this end, FIG. 6 is a flow chart illustrating one exemplary method 600 for controlling a vehicle, where at 602, the vehicle sensor system 102 acquires sensor data from the roadway environment surrounding the vehicle 100. At 604, the second vehicle 154 is identified by the second vehicle identification section 154 based at least on the sensor data acquired by the sensor system 102. At 606, the ECU 146 may be configured to extract, from the map database 116, road information for the roadway environment including information on the lane path for the lane in which the second vehicle 154 is traveling (i.e., the first lane 124 shown in FIG. 3).

At 608, the position estimation section 156 may estimate a state vector of the second vehicle 154 at a first time step based on the sensor data and the road information. The state vector may include an x-y coordinate position of the second vehicle 154 relative to the lane in which the second vehicle 154 travels. Furthermore, at 608, the velocity estimation section 158 may be configured to estimate a velocity component of the second vehicle 154.

To achieve an accurate position estimation by the position estimation section 156, the road information extraction section 162 may extract the road information from the map database 116 to acquire, e.g., information about the road 122, the first lane 124, the second lane 126, the pedestrian walkway 128, the crosswalk 130, the first lane path 132, the second lane path 134, the third lane path 136, and the fourth lane path 138 (or information on like features of any environment in which the vehicle 100 is operating).

At 610, the estimated state vector 154 of the second vehicle 154 may be communicated to the first future position estimation section 164, which estimates a first future position of the second vehicle 154 based on the velocity v estimated by the velocity estimation section 158, a magnitude of which is assumed to remain constant, and the heading θ estimated by the heading estimation section 160, which is also assumed to remain constant. Specifically, the first future position estimation section 164 may generate a constant velocity prediction for the second vehicle 154 at a second time step by assuming the second vehicle 154 maintains the heading θ which remains constant and the velocity v which remains constant. The first future position of the second vehicle 154 may be estimated based on the heading and the velocity.

At 612, the second future position estimation section 166 may be configured to generate a lane snapping constant velocity prediction for the second vehicle 154 at the second time step by projecting the x-y coordinate position of the second vehicle 154 onto a lane center of the lane on which the second vehicle 154 travels to obtain a projected position of the second vehicle 154 in a lane-based coordinate system using Frenet coordinates. The second future position estimation section 166 may be configured to convert the velocity component of the second vehicle 154 from Cartesian coordinates to the lane-based coordinate system, predicting a future position and a future velocity of the second vehicle 154 in the lane-based coordinate system, transforming the future position and the future velocity from Frenet coordinates to transformed Cartesian coordinates to approximate the lane center as a straight line near the second vehicle 154. The second future position estimation section 166 may estimate a second future position of the second vehicle 154 based on the transformed Cartesian coordinates.

At 614, the third future position estimation section 168 may estimate a third future position of the second vehicle 154 at the second time step by combining the first future position and the second future position through Bayesian statistical methods, which will be explained in detail below. The ECU 146 may be configured to iteratively update the state vector of the second vehicle 154 for a subsequent prediction cycle using the third future position as a starting point, and repeatedly iteratively update the state vector in this manner using each subsequent third future position as a next starting point for a plurality of time steps within a predetermined time horizon.

In an embodiment, the ECU 146 may be configured to determine a trajectory of the vehicle 100 based on the third future position of the second vehicle 154 estimated by the third future position estimation section 168. The determined trajectory may then be used by the ECU 146 to control the vehicle actuator system 104, thereby enabling the vehicle 100 to respond to predicted movements of the second vehicle 154 in real-time. Furthermore, this method may be applied in estimating the third future position for each of a plurality of vehicles in the roadway environment, allowing for comprehensive prediction and control across various traffic participants. Additionally, the information gathered by the ECU 146 regarding the second vehicle 154 may be used by the vehicle 100 for other purposes, such as informing the driver about the surrounding environment, and is not intended to be limited.

As will be explained in detail below, to generate the constant velocity prediction, the ECU 146 may apply a transformation matrix to the state vector of the second vehicle 154, adding Gaussian noise with zero mean and constant variance to account for uncertainties. The combination of the constant velocity and lane snapping predictions may involve calculating a mean and variance using a weighted sum of both predictions and their associated covariances. The ECU 146 may be further programmed to adjust the variance of this combination based on factors such as the initial angular difference and the lateral displacement of the second vehicle 154 relative to the lane center, enhancing the accuracy of the final trajectory prediction.

Individually, the first and second future positions estimated by the first and second future position estimation sections 164, 166 may provide improvements on the multi-modal and interactive prediction models. For example, the constant velocity heading model is often accurate for vehicles, particularly those traveling on a highway. While the constant velocity heading model may lack any prediction of future acceleration patterns, acceleration is typically carried out over relatively short intervals and may be considered in the model by iteratively repeating the position, velocity, and heading estimation by the position estimation section 156, the velocity estimation section 158, and the heading estimation section 160. However, the constant velocity heading model is necessarily going to be responsive to driving states and road conditions, and consequently may have difficulty when modeling changes in velocity.

To facilitate prediction of vehicles assumed to travel at a constant magnitude of velocity, the lane snapping model assumes the vehicles will travel at a constant magnitude of velocity along a defined lane path. This is likely to be a correct assumption over most short-range prediction horizons. However, the lane snapping model may not accurately account for, e.g., variance of vehicle position within a lane, and may be too confident that a vehicle will follow its current path, which may create difficulty when a vehicle leaves a lane or enters an unmapped road like a parking lot or driveway. These potential issues increase in prevalence as a prediction horizon increases.

By combining the two models, the benefits of each may be secured while limiting the drawbacks. To this end, the third future position estimation section 168 combines the first future position estimated by the first future position estimation section 164 and the second future position estimated by the second future position estimation section 166 to yield an estimation of the third future position. The mathematical processes carried out by the ECU 146 in this context are detailed below as an explanatory example and should not be considered limiting. Moreover, the ECU 146 may execute these operations by utilizing relevant algorithms and parameters stored within its memory, or alternatively, through known methods of accessing stored data, in conjunction with the inputs previously described.

The processes of the ECU 146 associated with the method 600 may be characterized as a Gaussian Lane Keeping model that utilizes Bayesian statistics to combine multiple probabilistic prediction models.

Let Xₜ₋₁=[p_{x,t-1}, P_{y,t-1}, v_{x,t-1}, v_{y,t-1}] denote the state vector of the second vehicle 154 including the x-y components of the position and velocity of the second vehicle 154 at time t−1 (i.e., the first time step). The constant velocity prediction may be modeled as:

$${X}_{t}^{cv} = [ \begin{matrix}1 & 0 & Δ t & 0 \\ 0 & 1 & 0 & Δ t \\ 0 & 0 & 1 & 0 \\ 0 & 0 & 0 & 1\end{matrix} ] {X}_{t - 1} + [ \begin{matrix}{ϵ}_{{p}_{x}}^{cv} \\ {ϵ}_{{p}_{y}}^{cv} \\ {ϵ}_{{v}_{x}}^{cv} \\ {ϵ}_{{v}_{y}}^{c v}\end{matrix} ] := {AX}_{t - 1} + {ϵ}^{cv} \qquad ( 1 )$$

Where Δt is the time step and

$${ϵ}_{{p}_{x}}^{cv} , {ϵ}_{{p}_{y}}^{cv} , {ϵ}_{{v}_{x}}^{cv} , {ϵ}_{{v}_{y}}^{c v}$$

are zero mean Gaussian noises with constant variances

$${σ}_{cv , {p}_{x}}^{2} , {σ}_{cv , {p}_{y}}^{2} , {σ}_{cv , {v}_{x}}^{2} , {σ}_{cv , {v}_{y}}^{2} ,$$

respectively. Using equation (1), it follows that:

$$ℙ ( {X}_{t}^{c v} \vert {X}_{t - 1} ) = 𝒩 ( {AX}_{t - 1} , {\sum }_{c v} ) := 𝒩 ( {μ}_{cv , t} , {\sum }_{c v} ) \qquad ( 2 )$$

Where Σ_{cv}∈ [symbol] ^{4×4} is the diagonal covariance matrix with

$$[ {σ}_{cv , {p}_{x}}^{2} , {σ}_{cv , {p}_{y}}^{2} , {σ}_{cv , {v}_{x}}^{2} , {σ}_{cv , {v}_{y}}^{2} ]$$

along the diagonal.

In lane snapping with constant velocity, the second vehicle's 154 position is projected onto the lane center, and constant velocity is predicted along the lane. In the Frenet-Serret frame, let (sₜ₋₁, 0) denote the projection of the second vehicle 154 position (p_{x,t-1}, p_{y,t-1}) (in Cartesian coordinates) onto the lane defined by [symbol] . This projection may be expressed as sₜ₋₁=PROJECT(p_{x,t-1},p_{y,t-1}, [symbol] ), where PROJECT returns the s-coordinate of the Frenet coordinates projection onto the lane [symbol] defined by lane center waypoints. Let

$${𝒯}_{( s , d )}^{x} and {𝒯}_{( s , d )}^{y}$$

denote the transformations that convert Frenet coordinates to x and y Cartesian coordinates, respectively. Let

$$‖ {v}_{t - 1} ‖ = \sqrt{{v}_{x , t - 1}^{2} + {v}_{y , t - 1}^{2}}$$

be the vehicle speed and vs be the longitudinal velocity in Frenet frame with a magnitude ∥vₜ₋₁∥. The lane snapping with constant velocity prediction may be modeled as:

$${X}_{t}^{ls} [ \begin{matrix}{𝒯}_{( s , d )}^{x} & ( {s}_{t - 1} + ‖ {v}_{t - 1} ‖ Δ t , 0 ) \\ {𝒯}_{( s , d )}^{y} & ( {s}_{t - 1} + ‖ {v}_{t - 1} ‖ Δ t , 0 ) \\ {𝒯}_{( s , d )}^{x} ( {v}_{s} , 0 ) & \\ {𝒯}_{( s , d )}^{y} ( {v}_{s} , 0 ) & \end{matrix} ] + [ \begin{matrix}{ϵ}_{{p}_{x}}^{ls} \\ {ϵ}_{{p}_{y}}^{s} \\ {ϵ}_{{v}_{x}}^{s} \\ {ϵ}_{{v}_{y}}^{ls}\end{matrix} ] := g ( {X}_{t - 1} ) + {ϵ}^{ls} {\approx }^{{( 1 )}^{*}} g ( {μ}_{t - 1} ) + ∇ g ( {μ}_{t - 1} ) ( {X}_{t - 1} - {μ}_{t - 1} ) + {ϵ}^{ls} , \qquad ( 3 )$$

Where sₜ₋₁=PROJECT(p_{x,t-1}, p_{y,t-1}, [symbol] ), and

$${ϵ}_{{p}_{x}}^{ls} , {ϵ}_{{p}_{y}}^{ls} , {ϵ}_{{v}_{x}}^{ls} , {ϵ}_{{v}_{y}}^{ls}$$

are the zero mean Gaussian noises with constant variances

$${σ}_{ls , {p}_{x}}^{2} , {σ}_{ls , {p}_{y}}^{2} , {σ}_{ls , {v}_{x}}^{2} , {σ}_{ls , {v}_{y}}^{2} ,$$

respectively. The approximation (1)* is driven by the first-order Taylor series expansion of g(Xₜ₋₁) around the mean of the previous state μₜ₋₁, where ∇g(μₜ₋₁) is the Jacobian matrix containing the gradients of g(Xₜ₋₁) at μₜ₋₁.

Estimating Vg for a general curve may be challenging and does not have a closed-form expression due to the Cartesian to Frenet and Frenet to Cartesian transformations. To this end, and by using a line, the lane center curve around the projection point may be locally approximated. Let θᵢ be the slope of the lane center curve at the point of projection, and hence the slope of the approximate line-center line. Let d be the lateral displacement of the vehicle at point (p_{x,t-1}, p_{y,t-1}) with respect to the lane-center line. Let θᵥ be the vehicle heading with respect to the lane-center line. In this case, the following suffices:

$$g ( {X}_{t - 1} ) = [ \begin{matrix}{p}_{x , t}^{ls} \\ {p}_{y , t}^{ls} \\ {v}_{x , t}^{ls} \\ {v}_{y , t}^{ls}\end{matrix} ] \approx [ \begin{matrix}{p}_{x , t - 1}^{p} + ‖ {v}_{t - 1} ‖ Δ t cos {θ}_{l} \\ {p}_{y , t - 1}^{p} + ‖ {v}_{t - 1} ‖ Δ t sin {θ}_{l} \\ ‖ {v}_{t - 1} ‖ Δ cos {θ}_{l} \\ ‖ {v}_{t - 1} ‖ Δ sin {θ}_{l}\end{matrix} ] , where \qquad ( 4 )$$

$$( {p}_{x , t - 1}^{p} , {p}_{y , t - 1}^{p} ) = ( {p}_{x , t - 1} + d sin {θ}_{l} , {p}_{y , t - 1} - d cos {θ}_{l} ) ,$$

$$‖ {v}_{t - 1} ‖ = \sqrt{{v}_{x , t - 1}^{2} + {v}_{y , t - 1}^{2}} .$$

Using geometry, the lateral displacement corresponding to point (p_{x,t-1}+Δx, p_{y,t-1}+Δy) may be written as d_{Δx,Δy}=d −Δx sin θₗ+Δy cos θₗ. Therefore, it may be shown that

$$\frac{\partial {p}_{x , t - 1}^{p}}{\partial {p}_{x , t - 1}} = {cos}^{2} {θ}_{l} , \frac{\partial {p}_{y , t - 1}^{p}}{\partial {p}_{y , t - 1}} = {sin}^{2} {θ}_{l} , and \frac{\partial {p}_{x , t - 1}^{p}}{\partial {p}_{y , t - 1}} = \frac{\partial {p}_{y , t - 1}^{p}}{\partial {p}_{x , t - 1}} = sin {θ}_{l} cos {θ}_{l} .$$

Hence, ∇g(Xₜ₋₁) may be approximated as:

$$∇ g \approx [ \begin{matrix}{cos}^{2} {θ}_{l} & sin {θ}_{l} cos {θ}_{l} & \frac{{v}_{x} Δ t cos {θ}_{l}}{‖ {v}_{t - 1} ‖} & \frac{{v}_{y} Δ t cos {θ}_{l}}{‖ {v}_{t - 1} ‖} \\ sin {θ}_{l} cos {θ}_{l} & {sin}^{2} {θ}_{l} & \frac{{v}_{x} Δ t i n {θ}_{2}}{‖ {v}_{t - 1} ‖} & \frac{{v}_{y} Δ t sin {θ}_{l}}{‖ {v}_{t - 1} ‖} \\ 0 & 0 & \frac{{v}_{x} cos {θ}_{l}}{‖ {v}_{t - 1} ‖} & \frac{{v}_{y} cos {θ}_{l}}{‖ {v}_{t - 1} ‖} \\ 0 & 0 & \frac{{v}_{x} sin {θ}_{l}}{‖ {v}_{t - 1} ‖} & \frac{{v}_{y} sin {θ}_{l}}{‖ {v}_{t - 1} ‖}\end{matrix} ] \qquad ( 5 )$$

Where

$$\frac{{v}_{x}}{‖ {v}_{t} - 1 ‖} = cos ( {θ}_{l} + {θ}_{v} ) and \frac{{v}_{y}}{‖ {v}_{t - 1} ‖} = sin ( {θ}_{l} + {θ}_{v} ) .$$

Using (3), it follows that:

$$ℙ ( {X}_{t}^{l s} \vert {X}_{t - 1} , ℓ ) = 𝒩 ( {μ}_{ls , t} , {Σ}_{l s} ) \qquad ( 6 )$$

Where μ_{ls,t}:=g(μₜ₋₁)+∇g(μₜ₋₁)(Xₜ₋₁−μₜ₋₁) and Σₗₛ∈ [symbol] ^{4×4} is the diagonal covariance matrix with

$$[ {σ}_{ls , {p}_{x}}^{2} , {σ}_{ls , {p}_{y}}^{2} , {σ}_{ls , {v}_{x}}^{2} , {σ}_{ls , {v}_{y}}^{2} ]$$

along the diagonal.

The constant variances

$${σ}_{ls , {p}_{x}}^{2} , {σ}_{ls , {p}_{y}}^{2} , {σ}_{ls , {v}_{x}}^{2} , {σ}_{ls , {v}_{y}}^{2}$$

may be modeled as a function of the initial vehicle angular difference and lateral displacement with the lane center. This ensures that the lane snapping with constant velocity model's confidence is higher when the vehicle is laterally closer to a lane with a smaller angular difference.

Let I denote the identity matrix. Let K∈ [symbol] ^{4×4} and Σ∈ [symbol] ^{4×4} be diagonal matrices with diagonal entries

$${K}_{i , i} = \frac{{σ}_{cv , {X}_{i}}^{2}}{{σ}_{cv , {X}_{i}}^{2} + {σ}_{ls , {X}_{i}}^{2}} and {Σ}_{i , i} = \frac{{σ}_{cv , {X}_{i}}^{2} {σ}_{ls , {X}_{i}}^{2}}{{σ}_{cv , {X}_{i}}^{2} + {σ}_{ls , {X}_{i}}^{2}} ,$$

respectively, where

$${σ}_{m , {X}_{1}}^{2} := {σ}_{m , {p}_{x}}^{2} , {σ}_{m , {X}_{2}}^{2} := {σ}_{m , {p}_{y}}^{2} , {σ}_{m , {X}_{3}}^{2} := {σ}_{m , {v}_{x}}^{2} , {σ}_{m , {X}_{4}}^{2} := {σ}_{m , {v}_{x}}^{2} ,$$

for m∈{cv,ls}. Let the prior belief be given by [symbol] (pₜ₋₁)= [symbol] (μₜ₋₁,Σₜ₋₁). The GLK method merges two prediction models by exploiting their joint prediction, i.e.,

$$ℙ ( {X}_{t}^{G L K} = {X}_{t} \vert ℓ ) := ℙ ( {X}_{t}^{c v} = {X}_{t} , {X}_{t}^{l s} = {X}_{t} \vert ℓ ) .$$

Now it may be shown that the GLK prediction at each timestep is a Gaussian for which the mean and the variance may be determined.

Given the mean μₜ₋₁ and the variance Σₜ₋₁ of the Gaussian prediction at t−1, i.e, [symbol] (Xₜ₋₁)= [symbol] (pₜ₋₁,Iₜ₋₁), the GLK prediction at time t is given by [symbol] (μ_{GLK,t},Σ_{GLK,t}), where μ_{GLK,t}=(1−K)Aμₜ₋₁+Kg(μₜ₋₁) and Σ_{GLK,t}=MΣₜ₋₁M^{T}+Σ, where M:=(I −K)A+K∇g(μₜ₋₁).

Proof: Using (2) and (6), it follows that:

$$\begin{matrix}ℙ ( {X}_{t}^{c v} , {X}_{t}^{l s} \vert {X}_{t - 1} , ℓ ) {=}^{{( 2 )}^{*}} ℙ ( {X}_{t}^{c v} \vert {X}_{t - 1} , ℓ ) ℙ ( {X}_{t}^{l s} \vert {X}_{t - 1} , ℓ ) \\ = 𝒩 ( {μ}_{X} , {Σ}_{X} )\end{matrix}$$

Where equality (2)* is driven by the independence of two prediction models and μₓ=(I −K)μ_{cv,t}+Kμ_{ls,t}=MXₜ₋₁+N and Σ_{X}=Σ, where M:=(I − K)A +K∇g(μₜ₋₁) and N:=K(g(pₜ₋₁) −∇g(μₜ₋₁)μₜ₋₁). It follows that:

$$\begin{matrix}ℙ ( {X}_{t}^{GLK} \vert ℓ ) = {\int }_{{X}_{t - 1}} ℙ ( {X}_{t}^{cv} , {X}_{t}^{ls} \vert {X}_{t - 1} , ℓ ) ℙ ( {X}_{t - 1} \vert ℓ ) \\ = {\int }_{{X}_{t - 1}} 𝒩 ( {μ}_{X} , {Σ}_{X} ) 𝒩 ( {μ}_{t - 1} , {Σ}_{t - 1} ) \\ {=}^{{( 3 )}^{*}} 𝒩 ( {μ}_{GLK , t} , {Σ}_{GLK , t} )\end{matrix} \qquad ( 7 )$$

Where equality (3)* is obtained similar to a belief update step via a Kalman filter and μ_{GLK,t} and Σ_{GLK,t} are given by:

$${μ}_{G LK , t} = M {μ}_{t - 1} + N = ( I - K ) A {μ}_{t - 1} + K g ( {μ}_{t - 1} ) \qquad ( 8 )$$

$${Σ}_{G LK , t} = M {Σ}_{t - 1} {M}^{T} + {Σ}_{X} \qquad ( 9 )$$

For brevity and simplicity, it may be assumed that

$${σ}_{cv , {p}_{x}}^{2} = {σ}_{cv , {p}_{y}}^{2} = {σ}_{cv , {v}_{x}}^{2} = {σ}_{cv , {v}_{y}}^{2} := {σ}_{cv}^{2} and {σ}_{ls , {p}_{y}}^{2} = {σ}_{ls , {v}_{x}}^{2} = {σ}_{ls , {v}_{y}}^{2} := {σ}_{ls}^{2} .$$

The base Gaussian Lane Keeping algorithm is presented as Algorithm 1 below. In Algorithm 1, V(v_{x,t-1}, v_{y,t-1}, [symbol] ) aligns the vehicle speed along the lane center and [symbol] _{(s,d)(x,y)} denotes the conversion from Frenet to Cartesian coordinates. Algorithm 1 and its associated explanation are not intended to be limiting, and it is understood that variations of Algorithm 1 may be implemented while still achieving similar results.

Algorithm 1: Gaussian Lane Keeping (Base model)

| 1 | Input: vehicle position p [symbol] velocity [symbol] , lane center [symbol] , time | |
|---|---|---|
| | $\begin{matrix}step Δ t , time horizon T , variances {σ}_{m}^{2} ( constant velocity ) \\ and {σ}_{f} \text{?} ( \text{?} snapping \text{?}\end{matrix}$ | |
| 2 | Output: prediction vector P | |
| 3 | Initialize: t = 1, P = [symbol] ; Identity matrix I ∈ [symbol] ^{4×4}, | |
| | Matrix A (see (3)), X₀ = [p [symbol] , p [symbol] , u [symbol] , u [symbol] ]^{T} | |
| 4 | μ₁₋₂ ← X₀, Σ₁₋₂ ← 0 Prior mean and Variance | |
| 5 | $K ← \frac{\text{?}}{( \text{?} + σ f )} I Compute k$ | |
| 6 | $\sum ← \frac{\text{?}}{( \text{?} + σ \text{?} )} I Compute \sum$ | |
| 7 | for i ≤ T do | |
| 8 | \| | μ [symbol] ← [symbol] μ [symbol] Constant velocity prediction |
| 9 | \| | (p [symbol] , p [symbol] , u [symbol] , u [symbol] ) ← μₜ₋₁ Prior estimate |
| 10 | \| | (sₜ₋₁, 0) ← PROJECT(p [symbol] , p [symbol] [symbol] ) Projection |
| | \| | on [symbol] in Prenet frame |
| 11 | \| | [symbol] ← s [symbol] + [\|u [symbol] \|]Δt Lane snapping position |
| | \| | prediction in Frenet frame |
| 12 | \| | v [symbol] ← V(u [symbol] , v [symbol] , [symbol] ) Lane snapping velocity |
| | \| | prediction in Frenet frame |
| 13 | \| | $μ \text{?} ← 𝒯 \text{?} \text{?} \text{?} , 𝒯 \text{?} \text{?} \text{?} Calculate lane$ |
| | \| | snapping prediction by converting to Cartesian fram |
| 14 | \| | μ_{GLK,t} ← (I − K)μ [symbol] + Kμ [symbol] GLK mean |
| 15 | \| | Estimate ∇ [symbol] using (7) Estimate Jacobian |
| 16 | \| | M ← (I − K)A + K∇g(μₜ₋₃) Calculate M |
| 17 | \| | Σ_{OLK,t} ← MΣₜ₋₁M^{T} + Σ GLK variance |
| 18 | \| | P ← APPEND(P [symbol] , μ_{GLK,t}_{₁} Σ_{GLK,t}) Append |
| | \| | μ_{GLK,t} and Σ_{GLK,t} to prediction vector P |
| 19 | \| | μᵢ₋₁ ← μ_{GLK,t}, Σₜ₋₁ ← Σ_{GLK,t} Update prior |

| | |
|---|---|
| 20 | end |

[symbol]

indicates data missing or illegible when filed

In an exemplary embodiment, the baseline models may be integrated with multi-modal capabilities by associating the vehicle with multiple lane centers based on predefined lateral distance and orientation thresholds relative to each lane center. When a vehicle is associated with multiple lane centers, the prediction model may generate trajectory predictions for each of these associated lane centers, resulting in a set of multi-modal predictions. This approach may leverage the diverse possibilities inherent in vehicle motion, ensuring that predictions are not overly constrained and ultimately leading to more accurate and robust results. In the case of multi-modal prediction, probabilities for each predicted trajectory may be estimated based on the heading angle or learned to model the likelihood of each trajectory.

In an exemplary embodiment, variations in velocity may be accounted for by utilizing a physics-based interactive model, such as the Intelligent Driver Model (IDM). IDM is a widely used mathematical model in traffic engineering that simulates driver behavior under varying traffic conditions, predicting how drivers adjust their speed to maintain safe distances. The model may consider factors such as a driver's desired speed, vehicle spacing, and reaction times to calculate acceleration. The IDM may calculate acceleration (a) as follows:

$$a = {a}_{max} [ 1 - {( \frac{v}{{v}_{0}} )}^{4} - {( \frac{{s}^{*}}{s} )}^{2} ] \qquad ( 10 )$$

Where, s* represents the desired safety gap (minimum following distance), defined as:

$${s}^{*} = {s}_{0} + {s}_{1} \sqrt{\frac{v}{{v}_{0}}} + v \cdot T + \frac{v ( v - {v}_{lead} )}{2 \sqrt{{a}_{max} b}} \qquad ( 11 )$$

The parameters v₀, s₀, s₁, T, aₘₐₓ, b pertain to the IDM model, signifying the driver's desired speed, preferred minimal gap, quantitative agreement parameter, driver's desired time headway, maximum comfortable acceleration, and comfortable deceleration, respectively.

To enhance the interactivity of the GLK model, the IDM may be employed to predict vehicle velocities when a leading vehicle is present. In the absence of a leading vehicle, a constant velocity assumption is applied. This selective use of the IDM ensures accurate predictions while avoiding unrealistic acceleration expectations for stationary vehicles. IDM parameters may be estimated in real time using a particle filter, which identifies the parameter set with the highest weight to predict the vehicle's acceleration at each time step.

In view of the above, it is noted that the predicted future position of the second vehicle 154 used herein references a “position.” However, it is to be appreciated that the system and method may readily be modified to predict a future trajectory (velocity and heading) of the second vehicle 154, or some combination of the position and trajectory of the second vehicle 154. Additionally, the term “constant” used above with reference to the velocity v and heading θ may mean substantially consistent/uniform, though does not necessarily require a precise constant assumption (i.e., minor variance in the velocity and or the magnitude of the velocity may be accounted for, possibly in the Gaussian modeling).

It is also noted that the manner of combining the first and second future position estimations to yield the third future position estimation may be modified. For example, a predetermined or dynamic weighting may be applied to the estimated first and second future positions to find the third future position which more heavily reflects one or the other of the estimated first and second future positions. Furthermore, the process of estimating the first to third future positions of the second vehicle 154 may be carried out repeatedly and iteratively, so as to allow for the estimation of the first to third future positions to update as the observed state of the second vehicle 154 changes. For example, using the example illustrated in FIG. 3, if the second vehicle 154 brakes suddenly and sharply, repeatedly and iteratively updating the velocity v and heading θ estimations will allow for the estimation of the first to third future positions to update and account for the change in the driving state of the second vehicle 154.

Additionally, the system and method described above may be modified to account for, e.g., the travel of the second vehicle 154 along a curved road. Specifically, in place of using a constant heading θ, inclusion of a rate of curvature to the assumed heading θ may be employed. In this regard, in cases where the second vehicle is turning or following a curve, such as in FIGS. 3 and 5, detection of the second vehicle 154 turning or following the curve may be made when θₜ−θₜ₋₁>ϵ, where ϵ is a predetermined angle and t is a time point.

When the second vehicle 154 is determined to be turning or following the curve, an assumption may be made that the turn or curve will eventually cease, i.e., that the second vehicle 154 is not driving in a circle. As such, the turning of the second vehicle 154 may be decayed over a prediction horizon, by applying the following equation:

$${θ}_{t + i + 1} ← {θ}_{t + i} + {d}^{i} δ {θ}_{t + i , t + i - 1} \qquad ( 12 )$$

Where i indexes the prediction step and the rate of decay d is 0≤d≤1, so that lower values of d yield faster decay.

The heading calculated by the above equation (12) may then used in place of the constant heading θ in estimating the first future position, and the remainder of the above system and method operates as described above.

As a further modification, the system and method described above may be utilized in select circumstances where the predictions provided thereby are more accurate. For example, the system and method described above may be deemed to provide for more accurate predictions of the position of the second vehicle 154 on a highway, as changes in velocity and heading may be less frequent and/or more predictable on a highway than in city driving. As such, the ECU 146 may be configured to detect highway driving of the vehicle 100 and switch from the multi-modal and interactive prediction models used for city driving to the combined constant velocity heading and lane snapping model described above for highway driving.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A vehicle control system provided in a vehicle for predicting future positions of a second vehicle, comprising:
a vehicle sensor system configured to acquire sensor data from a roadway environment surrounding the vehicle; and
a vehicle electronic control unit (ECU) in communication with the vehicle sensor system, a vehicle actuator system of the vehicle, and a map database, wherein the ECU is programmed to:
identify the second vehicle based on the sensor data acquired;
extract, from the map database, road information for the roadway environment including information on a lane path for a lane in which the second vehicle is traveling;
estimate a state vector of the second vehicle at a first time step based on the sensor data and the road information;
generate a constant velocity prediction for the second vehicle at a second time step by assuming the second vehicle maintains a heading which remains constant and a velocity which remains constant, and estimate a first future position of the second vehicle based on the heading and the velocity;
generate a lane snapping constant velocity prediction for the second vehicle at the second time step, and estimate a second future position of the second vehicle;
estimate a third future position at the second time step by combining the first future position and the second future position; and
iteratively update the state vector for a subsequent prediction cycle using the third future position as a starting point.

2. The vehicle control system according to claim 1, wherein
the ECU is further programmed to determine a trajectory of the vehicle based on the third future position of the second vehicle.

3. The vehicle control system according to claim 2, wherein
the ECU is further programmed to control the vehicle actuator system based on the trajectory determined based on the third future position of the second vehicle.

4. The vehicle control system according to claim 1, wherein the ECU is programmed to estimate the third future position of the second vehicle for each of a plurality of the second vehicle.

5. The vehicle control system of claim 1, wherein generating the constant velocity prediction includes applying a transformation matrix to the state vector and adding Gaussian noise with zero mean and constant variance.

6. The vehicle control system of claim 1, wherein combining the first future position and the second future position includes calculating a mean and variance of the combination using a weighted sum of the constant velocity prediction and the lane snapping constant velocity prediction and their associated covariances.

7. The vehicle control system of claim 6, wherein the ECU is further programmed to adjust the variance of the combination of the first future position and the second future position based on an initial angular difference and a lateral displacement of the second vehicle relative to a lane center.

8. The vehicle control system according to claim 1, wherein
in estimating, the first future position of the second vehicle, determining if a change in a heading angle of the second vehicle over a predetermined time is greater than a predetermined threshold and,
if the change in the heading angle of the second vehicle over the predetermined time is not greater than the predetermined threshold, estimate the first future position assuming the velocity and the heading will remain constant, and
if the change in the heading angle of the second vehicle over the predetermined time is greater than the predetermined threshold, estimate the first future position assuming the velocity will remain constant and that the heading will follow a curve decaying to a straight path over a predetermined horizon.

9. The vehicle control system according to claim 1, wherein the road information further includes information on an additional lane path for at least one additional lane adjacent to the lane in which the second vehicle is traveling on a road on which the second vehicle is traveling.

10. The vehicle control system according to claim 9, wherein
the at least one additional lane includes one of a crosswalk and a sidewalk,
the second vehicle is one of a pedestrian and a bicycle traveling on the one of the crosswalk and the sidewalk.

11. The vehicle control system of claim 1, wherein the ECU is further programmed to generate multi-modal predictions by associating the second vehicle with multiple lane centers in the roadway environment based on predetermined lateral distance and predetermined orientation thresholds, and estimating the third future position for each associated lane center of the multiple lane centers.

12. The vehicle control system of claim 1, wherein the ECU is further programmed to incorporate inter-agent interactions by integrating an Intelligent Driver Model (IDM) to determine a velocity of the second vehicle, applying the IDM when there is a leading vehicle ahead of the second vehicle, with IDM parameters estimated using a particle filter.

13. A method for controlling a vehicle, comprising using a vehicle electronic control unit (ECU) to:
identify a second vehicle, using sensor data acquired by a vehicle sensor system of the vehicle;
extract, from a map database, road information including information on a lane path for a lane in which the second vehicle is traveling;
estimate a state vector of the second vehicle at a first time step based on the sensor data and the road information;
generate a constant velocity prediction for the second vehicle at a second time step by assuming the second vehicle maintains a heading which remains constant and a velocity which remains constant, and estimate a first future position of the second vehicle based on the heading and the velocity;
generate a lane snapping constant velocity prediction for the second vehicle at the second time step, and estimate a second future position of the second vehicle;
estimate a third future position at the second time step by combining the first future position and the second future position; and
iteratively update the state vector for a subsequent prediction cycle using the third future position as a starting point.

14. The method for controlling the vehicle according to claim 13, wherein
the ECU is further programmed to determine a trajectory of the vehicle based on the third future position of the second vehicle.

15. The method for controlling the vehicle according to claim 14, wherein
the ECU is further programmed to control a vehicle actuator system of the vehicle based on the trajectory determined based on the third future position of the second vehicle.

16. The method for controlling the vehicle according to claim 13, wherein
the ECU is programmed to estimate the third future position of the second vehicle for each of a plurality of the second vehicle.

17. The method for controlling the vehicle of claim 13, wherein generating the constant velocity prediction includes applying a transformation matrix to the state vector and adding Gaussian noise with zero mean and constant variance.

18. The method for controlling the vehicle of claim 13, wherein combining the first future position and the second future position includes calculating a mean and variance of the combination using a weighted sum of the constant velocity prediction and the lane snapping constant velocity prediction and their associated covariances, and
the ECU is further programmed to adjust the variance of the combination based on an initial angular difference and a lateral displacement of the second vehicle relative to a lane center.

19. The method for controlling the vehicle according to claim 13, wherein
in estimating, the first future position of the second vehicle, determining if a change in a heading angle of the second vehicle over a predetermined time is greater than a predetermined threshold and,
if the change in the heading angle of the second vehicle over the predetermined time is not greater than the predetermined threshold, estimate the first future position assuming the velocity and the heading will remain constant, and
if the change in the heading angle of the second vehicle over the predetermined time is greater than the predetermined threshold, estimate the first future position assuming the velocity will remain constant and that the heading will follow a curve decaying to a straight path over a predetermined horizon.

20. A vehicle, comprising:
a vehicle sensor system;
a vehicle actuator system; and
a vehicle electronic control unit (ECU) in communication with the vehicle sensor system, the vehicle actuator system, and a map database, the ECU being programmed to:
identify a second vehicle different than the vehicle, using sensor data acquired by the vehicle sensor system of the vehicle;
extract, from the map database, road information including information on a lane path for a lane in which the second vehicle is traveling;
estimate a state vector of the second vehicle at a first time step based on the sensor data and the road information;
generate a constant velocity prediction for the second vehicle at a second time step by assuming the second vehicle maintains a heading which remains constant and a velocity which remains constant, and estimate a first future position of the second vehicle based on the heading and the velocity;
generate a lane snapping constant velocity prediction for the second vehicle at the second time step, and estimate a second future position of the second vehicle;
estimate a third future position at the second time step by combining the first future position and the second future position; and
iteratively update the state vector for a subsequent prediction cycle using the third future position as a starting point.
